(19) United States
(12) Patent Application Publication
(10) Pub. No.: US 2005/0124307 A1
(43) Pub. Date: Jun. 9, 2005

(54) Low cost broadband wireless communication system

(75) Inventors: Danny F. Ammar, Windermere, FL (US); David M. Bills, Orlando, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: XYTRANS, INC.

(21) Appl. No.: 11/005,626

(22) Filed: Dec. 6, 2004

Related U.S. Application Data
(60) Provisional application No. 60/527,911, filed on Dec. 8, 2003.

(51) Int. Cl. H04H 1/00

(52) U.S. Cl. 455/183.2; 455/259

(57) ABSTRACT

This present invention includes an indoor unit (IDU) and compact outdoor unit (ODU) having an intermediate frequency/modem circuit, millimeter wave transceiver circuit, and digital interface between the IDU and the ODU capable of up to about 100 MBps data rate over at least about a 300 meter cable. The system uses a conversion to the polar coordinate system completes calculations in the polar coordinate system, reducing the computational requirements, and therefore, the size and cost of the system.

### RELATED APPLICATION

This application is based upon prior filed copending provisional application Ser. No. 60/527,911 filed Dec. 8, 2003.

### FIELD OF THE INVENTION

This invention relates to the field of wireless communications systems, and more particularly, this invention relates to millimeter wave wireless communications systems that include an indoor unit and an outdoor unit.

### BACKGROUND OF THE INVENTION

Co-pending and commonly-assigned U.S. patent application Ser. No. 10/338,773 filed Jan. 8, 2003, the disclosure which is hereby incorporated by reference in its entirety, discloses a millimeter wave (MMW) outdoor unit that overcomes the disadvantages associated with the increased demand for high-speed, high-data rate communication requiring broadband access to any related network infrastructure. The outdoor unit overcomes the prior art problem of fabricating and testing outdoor units that are expensive, require manual labor, and have low operational reliability. It advantageously reduces the size and cost of a conventional, broadband outdoor unit used in high data rate wireless communications. The size of that outdoor unit is reduced and easily integrated into existing hardware components of communication systems, for example, by mounting the outdoor unit on an existing antenna. The outdoor unit can easily be integrated into tower installations to reduce costs, allowing network service providers to offer consumers a more affordable service.

The millimeter wave outdoor unit disclosed in the '733 application includes a housing in which different components are contained. A mounting member is configured for mounting directly on the antenna. This mounting member includes transmit and receive waveguide ports. A millimeter wave transceiver board is formed preferably of a ceramic material and is mounted within the housing, and includes thereon a millimeter wave transceiver circuit, including microwave monolithic integrated circuit (MMIC) chips that are operable with the transmit and receive ports.

An intermediate frequency (IF) board is mounted in the housing and includes components that form an intermediate frequency circuit operable with the millimeter wave transceiver circuit. A frequency synthesizer board with appropriate circuitry is also mounted within the housing. A controller board has surface mounted DC and low frequency discrete devices forming power and control circuits that supply respective power and control signals to other circuits on the other boards mounted within the housing. Circuit contact members interconnect the circuits between the different boards, thus minimizing the use of cables and wiring harnesses. A quick connect/disconnect assembly, for example, one or more snap fasteners, is operative with the housing, allowing the housing to be rapidly connected and disconnected to and from the antenna.

Although an efficient and small outdoor unit is disclosed in this '773 application, it would be preferred if other size and cost reductions are added to the system and an improved digital interface to the outdoor unit provided.

### SUMMARY OF THE INVENTION

This present invention advantageously reduces the size and cost of prior art high data rate wireless communication systems using an outdoor unit by a factor of ten without sacrificing the functionality, performance or reliability, which are so important in broadband communications. The system architecture of the present invention includes an indoor unit (IDU), and a compact outdoor unit (ODU), which includes an intermediate frequency/modem circuit. A unique and unobvious digital interface is provided between the indoor unit and the outdoor unit, which is capable of at least about 100 MBps data rate over a minimum of about a 300 meter cable as one non-limiting example.

Prior art existing modem circuits have used complex calculation methods based upon the Cartesian coordinate system because the modems receive Cartesian data. The present invention, however, converts to a polar coordinate system at the receiver, at the earliest possible system state, and completes all further calculations in the polar coordinate system. This reduces the computational requirements, and therefore, reduces the size and cost of the overall system.

The present invention also provides a highly-integrated, low-cost, compact outdoor unit (ODU) with a built-in modem circuit. A flexible system architecture supports Quadrature Phase Shift Keying (QPSK) and Quadrature Amplitude Modulation (QAM) direct modulation/demodulation, resulting in high data rates exceeding 100 Megabits/Sec. The novel and unobvious modem design of the present invention reduces complexity and costs of the overall system by performing all computations in polar coordinates instead of Cartesian coordinates. A low-cost, high-data rate digital interface between the indoor unit and the outdoor unit eliminates the requirement for locating costly, radio frequency (RF) components in the indoor unit. The use of low-cost predistortion methods allows the measurement and correction of high-powered amplifier non-linearity.

The system for millimeter wave communications uses an outdoor unit and indoor unit in communication with each other. An outdoor unit receives and/or transmits millimeter wave communication signals and includes an intermediate frequency/modem circuit that processes millimeter wave communication signals using a polar coordinate system of calculation. A single coaxial connection extends between the indoor unit and outdoor unit. The outdoor unit includes a millimeter wave transceiver circuit comprising microwave monolithic integrated circuit (MMIC) chips. The outdoor unit also includes a housing in which an intermediate frequency/modem board, frequency synthesizer board, and millimeter wave transceiver board are contained. The millimeter transceiver board preferably comprises a ceramic board.

In one aspect of the present invention, the millimeter wave transceiver circuit comprises a transmit circuit chain, a receive circuit chain and a local oscillator circuit chain. A mixer circuit is operatively connected to the transmit circuit chain for down converting millimeter wave transmitter coupled signals back to an intermediate frequency.

The intermediate frequency/modem circuit further comprises a modulator circuit and demodulator circuit that support quadrature phase shift keying (QPSK) modulation or quadrature amplitude modulation (QAM). The intermediate frequency/modem circuit also includes a multiplexer/demultiplexer circuit that separates transmit from receive data and DC signal and command and control signals that have been time multiplexed together. A processor computes predistortion coefficients used to correct amplifier nonlinearity based on detected power and phase. The intermediate frequency/modem circuit is also operative for transmitting and/or receiving a packet of data having a preamble that is independent of data modulation. This preamble can be formed as a first stop symbol that corresponds to an absence of a carrier or zero amplitude and a second start symbol that is fixed in amplitude and phase for allowing amplitude and phase offset calibration.

In one aspect of the present invention, the outdoor unit for millimeter wave communication includes a millimeter wave transceiver board comprising microwave monolithic integrated circuit (MMIC) chips and an intermediate frequency/modem board operable with the millimeter wave transceiver board and operable for processing millimeter wave communications signals using the polar coordinate system calculations. A method is also disclosed.

### BRIEF DESCRIPTION OF THE DRAWINGS

Other objects, features and advantages of the present invention will become apparent from the detailed description of the invention, which follows when considered in light of the accompanying drawings in which:

FIG. 1 is block diagram of an example of prior art terrestrial outdoor unit showing basic functional circuit components used in such system.

FIG. 2 is a block diagram of an example of an outdoor unit of the present invention showing the relationship among a controller board, IF/modem board, frequency synthesizer board, and RF transceiver board contained within a housing for the outdoor unit.

FIG. 3 is a block diagram showing different functional components that can be incorporated within the controller board, IF/modem board, frequency synthesizer board and RF transceiver board such as shown in FIG. 2 in accordance with the present invention.

FIG. 4 is a graph showing an example of a zero-offset digital coding scheme that can be used in accordance with the present invention.

FIG. 5 is a block diagram showing a data framing system that can be used in accordance with the present invention.

FIG. 6A is a block diagram of an example of the circuit functions operative in the modem of the outdoor unit in accordance with the present invention.

FIG. 6B is a block diagram of an example of the circuit functions operative in the indoor unit modem section in accordance with the present invention.

FIG. 7A is a block diagram of a prior art digital demodulator section in a modem that uses a Cartesian system

FIG. 7B is a block diagram of an example of a digital demodulator section in the modem that uses a polar system in accordance with the present invention.

FIG. 8 is a block diagram showing a typical data packet that can be used in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

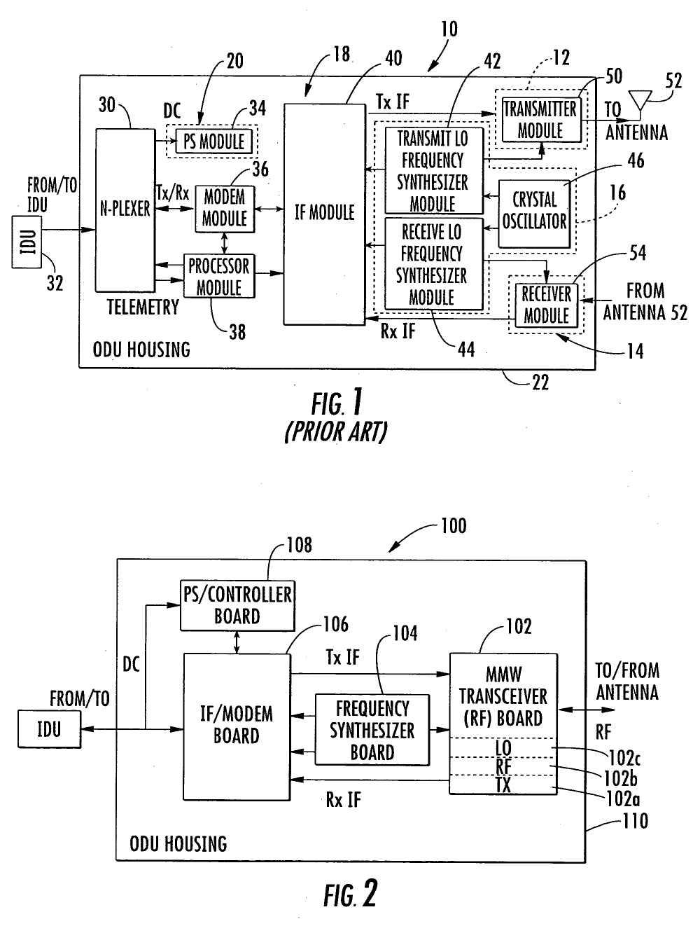

FIG. 1 is a block diagram of a prior art wireless, terrestrial outdoor unit 10 commonly used throughout the industry. This prior art outdoor unit 10 includes five subassemblies: 1) a millimeter wave (MMW) transmit section shown by dashed lines at 12; 2) a MMW receiver section shown by dashed lines at 14; 3) a frequency synthesizer section shown by the dashed lines at 16; 4) an IF/Processor section 18; and 5) a power supply (PS) section 20, typically all encased in an ODU housing 22.

This broad category of five basic sections includes various circuit functions. As illustrated, an N-multiplexer/demultiplexer 30 receives signals to and from an indoor unit 32. DC signals are sent to a power supply (PS) circuit module 34 to aid in controlling circuit functions and controlling overall power operation. Transmit and receive signals are passed to and from a modem circuit module 36 located between a processor circuit module 38 and an intermediate frequency circuit module 40. The processor circuit module 38 could be formed from a microprocessor microcontroller or similarly functioning processor circuit. This processor circuit module 38 sends and receives telemetry signals between the N-multiplexer/demultiplexer 30 and the intermediate frequency circuit module 40, operative, of course, with the modem circuit module 36.

Frequency synthesized signals are generated from a transmit local oscillator (LO) frequency synthesizer circuit module 42 and a receive local oscillator (LO) frequency synthesizer circuit module 44 as part of the IF section 16 and forward signals to the IF circuit module 40. The circuit modules 42, 44 are timed by a crystal oscillator 46. The transmit local oscillator (LO) frequency synthesizer circuit module 42 also generates signals to a transmitter circuit module 50, which also receives a transmitter intermediate frequency (IF) signal from the IF circuit module 40. Signals from the transmitter circuit module are also transmitted to an antenna 52. A receiver circuit module 54 receives signals from an antenna 52 and passes receiver intermediate frequency (IF) signals to the IF circuit module 40, while also recovering signals generated from the receive LO frequency synthesizer circuit module 44.

Each of these subassemblies is mounted to the housing 22 typically using screws and fasteners. In this type of prior art assembly, the subassemblies are connected to each other using expensive wiring harnesses and coaxial cables. Adding to the cost is that different vendors usually manufacture each of the different subassemblies. This outdoor unit 10 is assembled and tested by the radio manufacturer. Typically, this prior art outdoor unit 10 is manually assembled, tested, and characterized over temperature in large environmental chambers. This outdoor unit 10 typically weighs over 20 pounds and costs between five and ten thousand dollars at the current rate, depending on performance.

FIG. 2 is a block diagram showing basic functional components in the outdoor unit 100 of the present invention. This outdoor unit 100 eliminates all module subassemblies, which are typically expensive, and replaces them with three surface mount boards and one RF ceramic or “soft” RF board as illustrated.

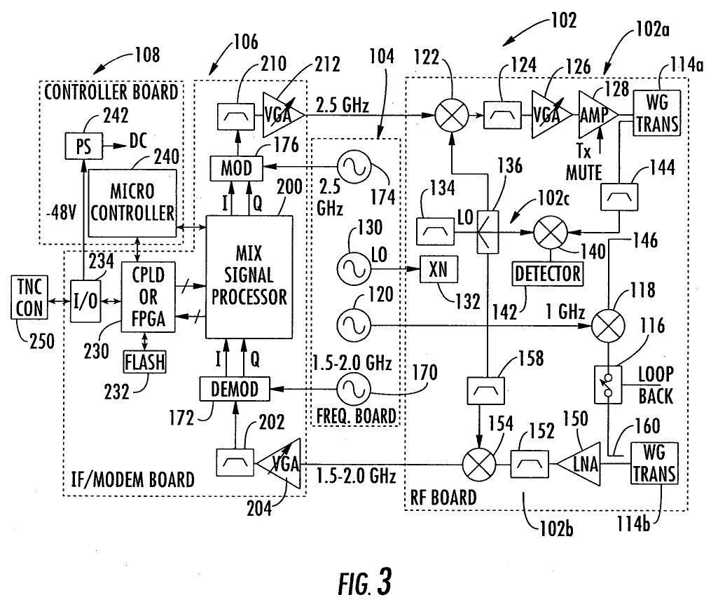

The outdoor unit 100 of the present invention includes a millimeter wave (MMW) transceiver RF board 102, a frequency synthesizer or generator board 104, an IF/modem board 106, and a power supply/controller board 108, all contained in the same outdoor unit housing 110. The MMW radio frequency (RF) transceiver board, which is made of ceramic or soft board, includes a transmit circuit chain 102a, a receive circuit chain 102b, and a local oscillator (LO) multiplier circuit chain 192c, with the functional circuit components shown in FIG. 3.

The MMW frequency (RF) board 102 includes respective transmit and receive waveguide transitions 114a, 114b, which are operative with a loop back switch circuit 116 and mixer 118. An oscillator signal is generated from an oscillator 120 on the frequency synthesizer or generator board 104 to this mixer 118 as illustrated. The transmit circuit chain 102a includes a mixer 122 that receives a signal from the intermediate frequency/modem board 106. After the mixer 122, this signal passes through a bandpass filter 124, a variable gain amplifier 126, and a second amplifier 128 into the waveguide transition 114a. Some of the amplifier circuits can be high power amplifiers. The amplifier circuit 128 can receive a transmit mute signal.

A local oscillator signal is generated by LO oscillator 130 on the frequency synthesizer board 104 and is received within the XN circuit 132 and passes through a bandpass filter 134 and a local oscillator splitter/processor circuit 136. A mixer 140 receives the signal and is operative with a detector circuit 142 and receives signals from the transmit waveguide transition 114a through a bandpass filter 144, and operative with the mixer 118 via loop back circuit 116 through a coupler 146. The receive signal is passed through the receive waveguide transition 114b into a low noise amplifier 150, bandpass filter 152 and a mixer 154 and passed to the intermediate frequency/modem board 106 after mixing with signals from LO splitter/processor circuit 136 via bandpass filter 158. An appropriate coupler circuit 160 provides coupling between loop back switch circuit 116 and the receive circuit chain 102b.

Any MMIC chips can be attached directly to the “soft” ceramic board, as described in commonly assigned U.S. Pat. No. 6,788,171, the disclosure which is hereby incorporated by reference in its entirety. This RF transceiver board 102 also includes appropriate circuitry for any transmitter output power and phase measurement. As illustrated and described above, a small portion of the transmitter output is coupled into the mixer, which is used to downconvert the MMW transmitter coupled signal back to a signal at an intermediate (IF) frequency. The IF signal is sent to a power and phase detector, for example, an AD8302 circuit chip made by Analog Devices Inc. This type of circuit chip can measure gain, loss and phase in the various receive transmit circuits. The chip incorporates a closely matched pair of demodulating logarithmic amplifiers having about a 60 dB measurement range. The difference in output allows a measurement of the magnitude ratio or gain between two input signals, even at different frequencies, this allowing measurement of conversion gain or loss. An unknown signal can be applied to one input and a calibrated AC reference signal to another to determine an absolute signal level. This circuit chip can include a multiplier phase detector with a precise phase balance. Further details are found in the AD8302 datasheet entitled, “LF-2.7 GHz RF/IF Gain and Phase Detector,” the disclosure which is hereby incorporated by reference in its entirety.

Any detected power and phase are sent to a processor, which computes predistortion coefficients used in the modem to correct the high power amplifier (HPA) nonlinearity as will be explained in greater detail below. The IF/modem board 106 receives digital data from the indoor unit (IDU) via a coaxial cable, unpacks the data, codes it, directly modulates the data to an IF frequency, and amplifies the signal using an IF amplifier as explained below.

The frequency synthesizer or generator board 104 includes a number of different oscillators that generate a local oscillator frequency for the transmitter circuit chain 102a and another for the mixer circuit chain 102c. A 1.5 to 2.0 GHz signal is produced from an oscillator 170 on the frequency synthesizer board 104 and passed to a demodulator circuit 172 on the intermediate frequency/modem board 106. Another oscillator 174 generates a 2.5 GHz signal for a modulator circuit 176 on the intermediate frequency/modem board 106. These are non-limiting examples of different frequencies that can be generated for use with the present invention.

The intermediate frequency/modem board 106 includes a mixed signal processor 200 that receives inphase/quadrature (I/Q) signals from the demodulator circuit 172, which in turn, receives signals from a bandpass filter 202 and variable gain amplifier 204 at 1.5 to 2.0 GHz. These signals had been passed from the mixer 154 in the receiver circuit chain 102b on the radio frequency board 102. The mixed signal processor 200 passes I/Q signals to the modulator circuit 176, which passes signals into a bandpass filter 210 and variable gain amplifier 212 and outputs signals at about 2.5 GHz into the mixer 122 in the transmit circuit chain 102a on the RF board 102 in this non-limiting example. A programmable logic device (CPLD) or field programmable gate array (FPGA) circuit 230 is operable with flash memory 232, the mixed signal processor 200, and input/output ports 234 of the IF/modem board 106, as will be explained in greater detail below.

The controller board 108 includes a microcontroller 240 as a processor circuit and a power supply circuit 242, operable at DC minus 48 volts. The power supply receives signals from the IF/modem board 106 via the input/output ports 234. The microcontroller 240 is functionally operative with the CPLD or FPGA 200 and mixed signal processor 200 as illustrated. The input/output ports 230 can connect to a conventional TNC connector 250.

The IF/modem board 106 also receives the receiver IF signal from the MMW transceiver board 102 and directly demodulates the signal to baseband, decodes it, digitizes the signal, packs it, and forwards the signal to the indoor unit. The frequency synthesizer board 104 generates the required local oscillator signals using a voltage controlled oscillator (VCO) design, which is phase locked to a crystal oscillator.

The outdoor unit 100 is preferably connected to the indoor unit via a single coax cable. The outdoor unit includes multiplexer functionality that separates the transmit data stream from the receive data stream, a DC signal, and control and command signals, which are all time multiplexed on the same coax cable. The power supply 242 converts high voltage DC signals (greater than −24 VDC) to the desired lower level DC signals required to run any amplifiers and control circuits. The microcontroller 240 (or microprocessor) provides all the control and monitor functions and interfaces with the indoor unit.

The microcontroller 240 also provides the “smarts” and microprocessor programming functions required to control any individual MMIC chips in the this unit, for example, by using techniques such as described in commonly assigned U.S. patent application Ser. No. 09/863,052, the disclosure which is hereby incorporated by reference in its entirety. These types of techniques can provide chip level self-diagnostics, transmitter gain and output power control without attenuator chips. It can also provide temperature compensation without an active attenuator and self-tuning. The controller can be operatively connected to a MMIC for sensing amplifier operating conditions and tuning the at least one amplifier to an optimum operating condition. The controller can be a surface mounted microcontroller chip operatively connected to the MMIC and have memory restored values of optimum operating conditions, such as preset MMIC characteristics, including optimum drain current and expected amplifier output at various stages in a radio frequency circuit. The memory could be an EEPROM.

The controller could also include a sensor for sensing changes and operating amplifier conditions and adjust the amplifier based on sensed changes in amplifier operating conditions. A digital potentiometer can be operatively connected to the amplifier for stepping gate voltage within the amplifier based on sensed changes and operating conditions. A multi-channel analog-to-digital converter can connect to the sensor for digitizing sensor output to be compared with stored values of optimum operating conditions.

The circuit can include a temperature sensor for measuring the temperature of the MMIC such that any controller is responsive to the sensed temperature for determining whether any change in amplifier operating conditions is a result of a change in temperature or malfunction. A power sensor diode can be operatively connected to at least one amplifier and the controller can be responsive to the power sensor diode for tuning an amplifier. The controller can also be operative for correcting one of at least: (a) gain variation over temperature; (b) linearization of the power monitor circuit as a function of temperature and frequency; (c) gain equalization as a function of frequency; and (d) power attenuation linearization as a function of frequency and temperature. All components, excluding the MMIC's, can be assembled a “soft” board using traditional surface mount methods.

The modulator circuit 176 can be a direct up-conversion quadrature modulator such as the AD8349 circuit chip manufactured by Analog Devices, Inc. The AD8349 circuit chip is a silicon, monolithic, RF quadrature modulator typically designed for use at 700 MHz to 2,700 MHz. It uses a differential local oscillator input signal split into an N-phase and quadrature-phase signal, which are buffered and mixed with a corresponding I and Q channel baseband signals in Gilbert cell mixers. Further details are disclosed in the AD8349 datasheet entitled, “700 MHz to 2,700 MHz Quadrature Modulator,” the disclosure which is hereby incorporated by reference in its entirety.

The demodulator circuit 172 can be a direct down-conversion quadrature demodulator such as the AD8347 circuit chip manufactured by Analog Devices, Inc. The AD8347 circuit chip is a broadband direct quadrature demodulator with RF and baseband automatic gain control amplifiers. Its input frequency ranges about 800 MHz to 2.7 GHz with outputs connected to analog-to-digital converters. An RF input signal can pass through stages of variable gain amplifiers prior to Gilbert cell mixers. A local oscillator quadrature phase splitter can use polyphase filters and the chip is operative as separate I and Q channel variable-gain amplifiers following mixing. The output level can be maintained by an automatic gain control (AGC) loop. Further details are set forth in the AD8347 datasheet entitled, “0.8 GHz-2.7 GHz direct Conversion Quadrature Demodulator,” the disclosure which is hereby incorporated by reference in its entirety.

The mixed signal processor could be formed from a AD9860 circuit chip manufactured by Analog Devices, Inc. This circuit chip can include digital to analog conversion and filtering of the transmit signal and analog to digital conversion of the received signal. The AD9860 circuit chip is an integrated mixed signal front end circuit and used in proprietary broadband modem systems having a number of analog-to-digital converters and digital-to-analog converters with a receive path of different channels, and using programmable gain amplifiers, digital Hilbert filters and a decimation filter. A transmit path includes different channels with various converters, interpolation filters, Hilbert filter and digital mixers. Further details of the AD9860 chip are disclosed in the AD9860 datasheet entitled, “Mixed-Signal Front-End (MxFe™) Processor for Broadband Communications,” the disclosure which is hereby incorporated by reference in its entirety.

The complex programmable logic device (CPLD) or field programmable gate array (FPGA) circuit 230 multiplexes transmit/receive and telemetry data, performs forward Error Correction (FEC), encodes the data into QPSK or QAM symbols and interfaces with the mixed signal processor 200.

The outdoor unit has a modular design, which allows the use of a single platform for a wide frequency range. By changing the RF board 102 and its frequency, it is possible to cover different frequency bands. A housing 110 and the IF/modem board 106 would be common for all frequencies from 7.0 to 60 GHz. Of course, the design and configuration of a waveguide opening in any housing will vary depending on the operating frequency band.

The system and method of the present invention advantageously enhanced the communications between the outdoor unit and the indoor unit. The communications are accomplished by inserting digital command data into the payload data. This allows for simple communication with virtually no RF components located at the indoor unit. Sending data as digital levels also allows for longer cable lengths with no system losses. A cable length up to about 300 meters can be realized in this design with limited operational loss.

The digital transmission uses an encoding scheme as shown in FIG. 4, where a “zero” value is a fixed reference level, while a “one” value is offset either positive or negative from the reference level. To reduce DC bias in the cable and signal drop, each “one” value is alternated from a positive offset to a negative offset. The signal strength of the transmission is detected by the receiver. The level of the line detect is also adjusted by the results of the signal strength detector.

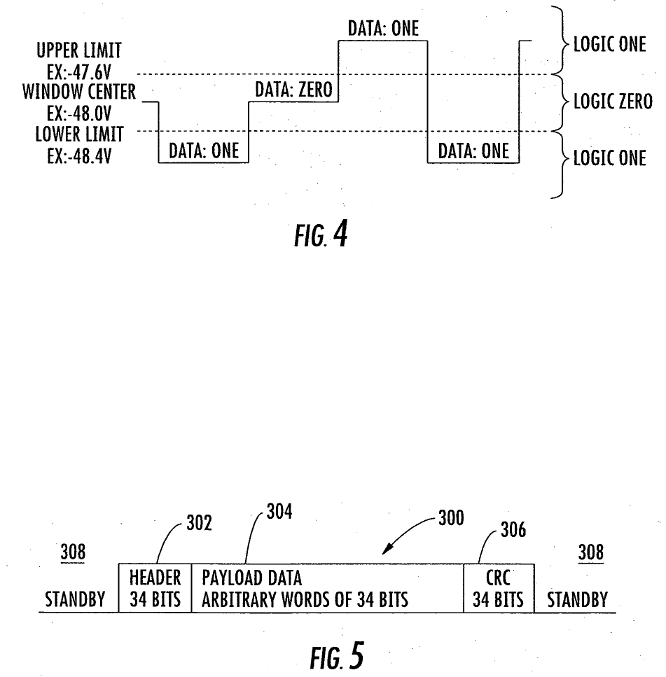

A communications rate of 100 mega-bits per second can be achieved through the use of custom digital drivers and receivers. As this system is half-duplex, the present system and method of the present invention incorporate a complete digital framing system. A date frame 300 is shown in FIG. 5 and the framing system includes forward error correction and the incorporation of control data mixed with the payload data transmission. As illustrated the frame 300 includes a header 302 that could be about 34 bits, a payload data 304 that could be formed from arbitrary words, each of about 34 bits, and a cyclic redundancy check (CRC) 306 of about 34 bits. “Standby” 308 is located on the other side of the frame.

To reduce complexity, the system preferably sends only one framed packet after it has received a packet. The size of the packets is dependent on the data rates, i.e., the largest size is desired for the existing bit error ratio and the system efficiency. In general, larger packets are used in a low error rate environment and smaller packets are used with a high error rate environment. System efficiency is degraded with a reduced packet size because of the “turn-around” time, or the transmission speed, of the packets being sent.

There are several functional circuit sections in modem circuits if the outdoor unit 100 and any indoor unit of the present invention. An analog portion of the demodulator contains automatic gain control functions. A digital demodulator section includes several functions, from clock recovery to symbol interpretation, which is described later. The forward error correction blocks, or FEC, is duplicated several times to increase performance, which allows errors in the serial coaxial cable to be isolated from errors in the IF/RF section.

The line drivers have been previously described and are multiplexed at the cable. The digital modulator 176 is a relatively simple function although it includes a predistortion capability with a closed-loop feedback from the opposite IF/RF link. This closed-loop feedback is performed on a regular, but low priority basis, by polling the receivers for deviations from desired values. Any errors found in I/Q levels are adjusted on the transmitter side for correction. The customer or user interface can be a simple synchronous parallel interface, which is commonly used by digital systems for memory access. Alternate interfaces can be added at a customer's discretion, such as Ethernet fiber-optics.

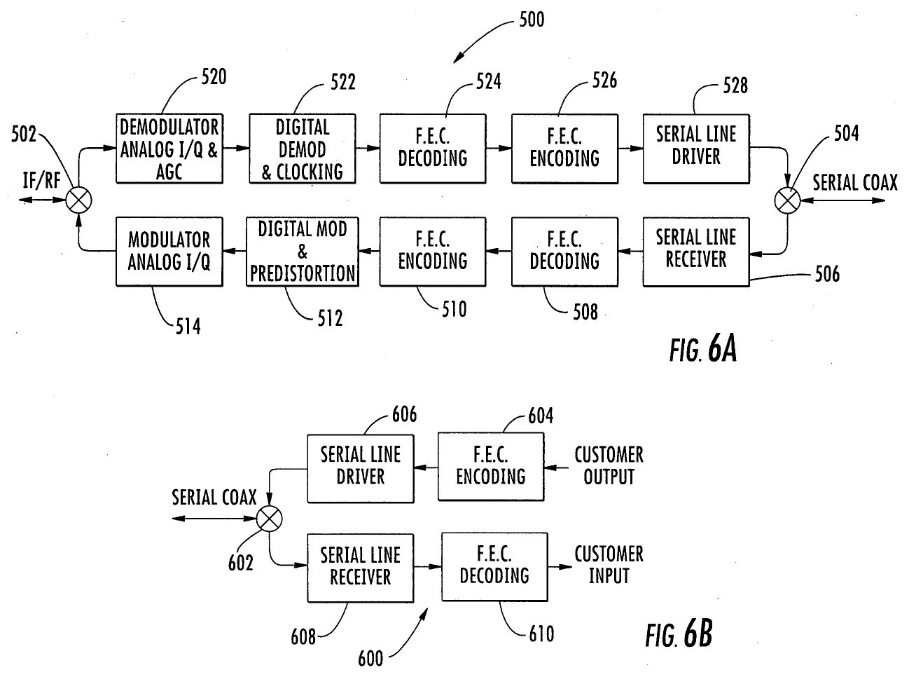

FIGS. 6A and 6B are block diagrams of modem circuit functions in the respective outdoor unit and indoor unit of the present invention. The circuit functions correspond to the components explained with reference to FIG. 3. FIG. 6A shows the functions of outdoor unit modem circuit 500 with two mixers 502, 504. The first mixer 502 receives an intermediate frequency/radio frequency (IF/RF) signal and the second mixer is operatively connected to a serial coaxial cable connection. The mixer at serial coaxial cable connection is operative with a serial line receiver circuit 506, followed by a forward error correction decoding circuit 508, and a forward error correction encoding circuit 510. The signal is processed at a digital modulator and predistortion circuit 512. Before entering the mixer 502, it passes through the modulator, analog I/Q circuit 514. Signals from the mixer at the intermediate frequency/radio frequency side are passed into the demodulator analog I/Q and automatic gain control (AGC) circuit 520, followed by digital demodulation and clocking 522. The signal passes through a forward error correction decoding circuit 524 and a forward error correction encoding circuit 526. It is then passed to a serial line driver circuit 528 and to the serial/coaxial mixer 504.

FIG. 6B shows circuit functions for an indoor unit modem circuit 600 of the present invention in which a mixer 602 is connected to the serial coaxial cable connection and receives a customer output that is passed into a forward error correction (FEC) encoding circuit 604, a serial line driver circuit 606 and into the mixer 602. Signals from the mixer 602 can be passed into the serial line receiver circuit 608 and forward error correction (FEC) decoding circuit 610 to be output as a signal for customer input.

As known to those skilled in the art, most existing modem circuits in indoor/outdoor units use complex calculation methods based upon the Cartesian coordinate system, because the received data is typically Cartesian. The present invention, however, converts data to the polar coordinate system at the receiver, at the earliest possible system state, and completes all further calculations in the polar coordinate system. These types of circuits of the present invention reduce the computational requirements, and therefore the size and costs of the finished systems. All conversions for data now can use simple and fast look-up tables, instead of the standard method of using digital signal processing techniques for Cartesian data. The reduction in computational requirements results in increasing the conversion rate, and reducing the cost with minimal performance loss to accuracy.

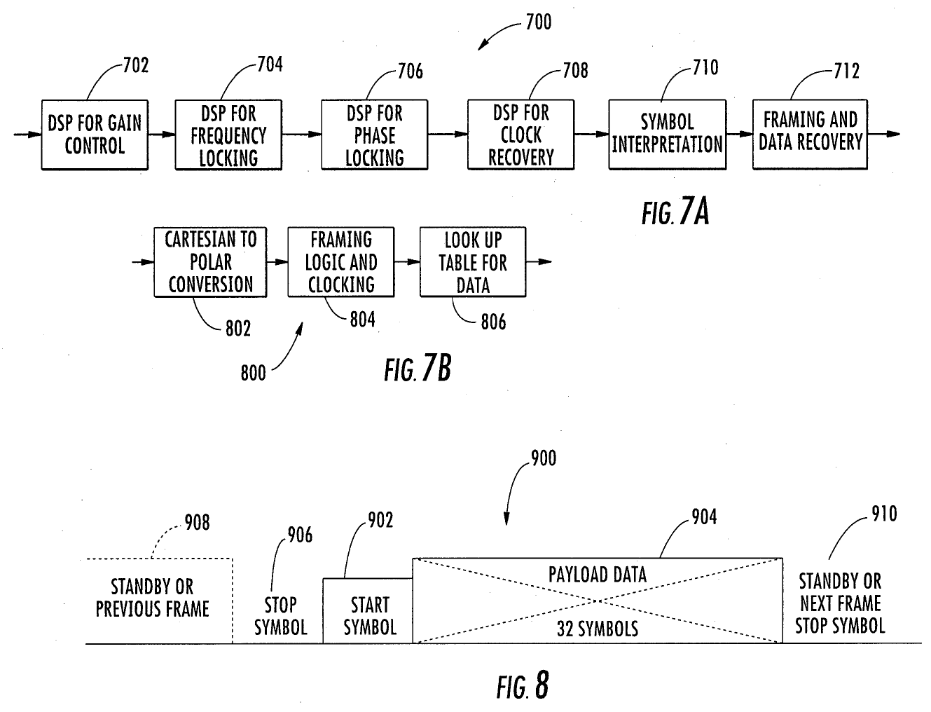

FIG. 7A is a block diagram of a prior modem digital demodulation section 700 used in a modem circuit, while FIG. 7B shows a modem digital demodulation section 800 used in a modem circuit of the present invention.

FIG. 7A shows basic components of this prior art digital demodulator circuit 700, including a digital signal processor circuit for gain control. This is followed by digital signal processing for frequency locking 704, digital signal processing for phase locking 706, and digital signal processing for clock recovery 708. These block component functions can be formed on one chip and be integrated circuits or separate. After clock recovery at circuit 708, a symbol interpretation circuit 710 processes data with appropriate coding for symbol interpretation. After symbol interpretation, the signal passes to framing and data recovery circuit 712.

In the present invention on the other hand, at the modem circuit signals are converted to polar configuration in a Cartesian to polar conversion circuit 802. A framing logic and clocking section 804 receives the polar signals and the processor is operative to query a look-up table for data 806.

In operation, the data is framed into a small packet sizes. This small packet size reduces timing errors and reduces the size of the preamble. While standard modem designs use an advanced symbol recovery system, in the present invention, on the other hand, the timing of symbols is calibrated during a short preamble and is maintained during the symbol frame by a standard clocking scheme.

During a normal standby state when data is not available for transmission, the transmitter modem circuit will send a continuous signal at fixed amplitude, but at a continuously changing phase. This signal is interpreted by the receiver modem circuit as a standby state because of the amplitude of the signal. This also means that a carrier frequency will always be present for RF system locking. The “standby” signal, which continuously phase changes, reduces any problems associated with the DC level “drooping” at the transmitter and receiver. A complete angular rotation in the positive direction will be followed by a complete angular rotation in the negative direction. This solves several system problems, for example, that of DC level centering, which could introduce errors in symbol recovery if the signal is not centered.

Although the preamble used in the present invention includes two symbol transmissions, it accomplishes several objectives. The first symbol has an absence of a carrier or amplitude of zero. This transmission level informs the system of a pending frame but does not initialize the timing of the frame. This “stop” symbol is used to calibrate any system Cartesian offsets. The second symbol, or “start” symbol, is a fixed amplitude and phase. This is understood by the receiver circuitry and allows for both amplitude and phase offset correction.

Consecutive frame-to-frame phase offsets can be used to determine angular rotation of the symbol phase and can be used to predict the average phase offset for the duration of the frame. The phase tracking during a frame is not required due to the short length of the frame. The modem complexity is reduced by eliminating angular rotation tracking during the frame. The “start” symbol is an indication of the start of the data stream. At the end of a frame the receiver can easily detect between a new “stop” symbol and entry into the “standby” state.

FIG. 8 shows a typical packet 900 with the preamble and the payload data of the present invention. The packet 900 includes a start symbol 902 and a payload data 904 of about 32 symbols. The front portion includes a stop symbol 906 and a standby or previous frame 908 at the front and a standby or next frame or stop symbol 910 at the back. The payload data 904 of the frame can be modulated in any of several modulation schemes such as QPSK or QAM. The modulation scheme has no functional relation to the two symbol preamble. The length of the data transmission in relation to the frequency of the preamble is a trade-off between the match of the local oscillator frequency of the transmitter and the local oscillator frequency of the receiver. An increase in the cost of the RF system will allow for longer data payload sections and therefore increase system efficiency. The use of a preamble that is independent of the data modulation technique is one notable feature of this invention.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

1. A system for millimeter wave communications, which comprises:
an indoor unit;
an outdoor unit in communication with the indoor unit and receiving and/or transmitting millimeter wave communications signals and including an intermediate frequency/modem circuit that processes the millimeter wave communications signals using a polar coordinate system of calculations.

2. A system according to claim 1, and further comprising a single coaxial connection extending between the indoor unit and outdoor unit.

3. A system according to claim 1, wherein said outdoor unit comprises a millimeter wave transceiver board comprising microwave monolithic integrated circuit (MMIC) chips.

4. A system according to claim 1, wherein said outdoor unit further comprises a housing and an intermediate frequency/modem board, a frequency synthesizer board and a millimeter wave transceiver board contained within the housing.

5. A system according to claim 4, wherein said millimeter wave transceiver board comprises a ceramic board.

6. A system according to claim 1, and further comprising a millimeter wave transceiver board comprising a transmit circuit chain, a receive circuit chain and a local oscillator circuit chain.

7. A system according to claim 6, and further comprising a mixer circuit operatively connected to said transmit circuit chain for down converting millimeter wave transmitter coupled signals back to an intermediate frequency.

8. A system according to claim 1, wherein said intermediate frequency/modem circuit further comprises a modulator circuit and demodulator circuit that support quadrature phase shift keying (QPSK) modulation or quadrature amplitude modulation (QAM).

9. A system according to claim 1, wherein said intermediate frequency/modem circuit comprises a multiplexer/demultiplexer circuit that separates transmit, receive, and command and control data that had been time multiplexed together.

10. A system according to claim 1, wherein said outdoor unit further comprises a processor that computes predistortion coefficients used to correct amplifier nonlinearity based on detected power and phase.

11. A system according to claim 1, wherein said intermediate frequency/modem circuit is operative for transmitting and/or receiving a packet of data having a preamble that is independent of data modulation.

12. A system according to claim 11, wherein the preamble has a first stop symbol that corresponds to an absence of a carrier or zero amplitude and a second start symbol that is fixed in amplitude and phase for allowing amplitude and phase offset calibration.

13. An outdoor unit for millimeter wave communication, which comprises:
a millimeter wave transceiver board comprising microwave monolithic integrated circuit (MMIC) chips; and
an intermediate frequency/modem board operable with the millimeter wave transceiver board and operable for processing millimeter wave communications signals using a polar coordinate system of calculations.

14. An outdoor unit according to claim 13, and comprising a connector adapted for connecting to a single coaxial connection for connecting to an indoor unit.

15. An outdoor unit according to claim 13, and further comprising a housing in which the millimeter wave transceiver board and intermediate frequency/modem board are contained.

16. An outdoor unit according to claim 13, wherein said millimeter wave transceiver board comprises a ceramic board.

17. An outdoor unit according to claim 13, wherein said millimeter wave transceiver board comprises a transmit circuit chain, a receive circuit chain and a local oscillator circuit chain.

18. An outdoor unit according to claim 17, wherein said millimeter wave transceiver board comprises a mixer circuit operatively connected to said transmit circuit chain for down converting millimeter wave transmitter coupled signals back to an intermediate frequency.

19. An outdoor unit according to claim 13, wherein said intermediate frequency/modem board further comprises a modulator circuit and a demodulator circuit that support quadrature phase shift keying (QPSK) modulation or quadrature amplitude modulation (QAM).

20. An outdoor unit according to claim 13, wherein said intermediate frequency/modem board further comprises a multiplexer/demultiplexer circuit that separates transmit, receive, and command and control data that had been time multiplexed together.

21. An outdoor unit according to claim 13, and further comprising a frequency synthesizer board operable to generate local oscillator signals for MMIC chips on the millimeter wave transceiver board.

22. An outdoor unit for millimeter wave communications, which comprises:
a housing;
a millimeter wave transceiver board contained in the housing and comprising microwave monolithic integrated circuit (MMIC) chips;
an intermediate frequency/modem board contained within the housing and operable with the millimeter wave transceiver board for processing millimeter wave communications signals; and
a circuit operable for detecting power and phase and computing predistortion coefficients for correcting any amplifier nonlinearity.

23. An outdoor unit according to claim 22, and further comprising a connector adapted for connecting to a single coaxial connection and to an indoor unit.

24. An outdoor unit according to claim 22, wherein said millimeter wave transceiver board comprises a ceramic board.

25. An outdoor unit according to claim 22, wherein said millimeter wave transceiver board comprises a transmit circuit chain, a receive circuit chain and a local oscillator circuit chain.

26. An outdoor unit according to claim 25, wherein said millimeter wave transceiver board comprises a mixer circuit operatively connected to said transmit circuit chain for down converting millimeter wave transmitter coupled signals back to an intermediate frequency.

27. An outdoor unit according to claim 22, wherein said intermediate frequency/modem board further comprises a modulator circuit and a demodulator circuit that support quadrature phase shift keying (QPSK) modulation or quadrature amplitude modulation (QAM).

28. An outdoor unit according to claim 22, wherein said intermediate frequency/modem board further comprises a multiplexer/demultiplexer circuit that separates transmit, receive, and command and control data that had been time multiplexed together.

29. An outdoor unit according to claim 22, and further comprising a frequency synthesizer board operable to generate local oscillator signals for MMIC chips on the millimeter wave transceiver board.

30. A method for millimeter wave communications using an outdoor unit and indoor unit in communication with each other, which comprises:
transmitting and/or receiving a millimeter wave communications signal within an intermediate frequency/modem circuit that is operative for communicating with a millimeter wave transceiver circuit; and
processing the communications signal within the intermediate frequency/modem circuit using a polar coordinate system of calculations.

31. A method according to claim 30, which further comprises transmitting a packet of data having preamble that is independent of data modulation.

32. A method according to claim 31, which further comprises modulating payload data with either quadrature phase shift keying or quadrature amplitude modulation.

33. A method according to claim 31, wherein the preamble has a first stop symbol that corresponds to an absence of a carrier or zero amplitude and a second start symbol that is fixed in amplitude and phase for allowing amplitude and phase offset calibration.

34. A method according to claim 33, which further comprises calibrating any Cartesian offsets by the stop symbol.

35. A method according to claim 33, which further comprises determining angular rotation of a symbol phase and predicting average phase offset for a duration of a frame by consecutive frame-to-frame phase offsets.

36. A method according to claim 33, which further comprises calibrating the timing of symbols during a preamble and maintaining during the symbol frame by the clocking.

37. A method according to claim 33, which further comprises transmitting a continuous signal at a fixed amplitude but at a continuously changing phase.

38. A method according to claim 37, which further comprises following an angular rotation in the positive direction with an angular rotation in the negative direction.

39. A method according to claim 30, which further comprises duplicating forward error correction blocks at least once to allow errors in a serial coaxial connection at the indoor unit and outdoor unit to be isolated from errors in the intermediate frequency/modem circuit.

40. A method according to claim 30, which further comprises communicating between the indoor unit and outdoor unit by inserting digital command data into the payload data.

41. A method according to claim 40, which further comprises establishing a fixed reference value as a zero value and a one value as offset either positive or negative from the reference level.

42. A method according to claim 30, which further comprises transferring signals along a single coaxial connection extending between the outdoor unit and indoor unit.

43. A method according to claim 30, which further comprises detecting power and phase and computing any predistortion coefficients used in the intermediate frequency/modem circuit for correcting amplifier nonlinearity.

44. A method according to claim 30, wherein the millimeter wave transceiver circuit includes a transmit circuit chain, a receive circuit chain and a local oscillator circuit chain.

45. A method according to claim 44, which further comprises coupling an output from the transmit circuit chain to a mixer circuit for down converting millimeter wave transmitter coupled signal back to an intermediate frequency.
